(19) United States
(12) Patent Application Publication
(10) Pub. No.: US 2025/0312868 A1
(43) Pub. Date: Oct. 9, 2025

(54) SYSTEM FOR LASER MARKING OF PRODUCTS

(71) Applicant: Husky Injection Molding Systems Ltd., Bolton (CA)

(72) Inventors: Joachim Johannes Niewels, Thornton (CA); Scott Stedman, Mississauga, Ontario (CA)

(73) Assignee: Husky Injection Molding Systems Ltd., Bolton, ON (CA)

(21) Appl. No.: 18/865,321

(22) PCT Filed: May 19, 2023
(86) PCT No.: PCT/CA2023/050700

§ 371 Date: Nov. 12, 2024

Related U.S. Application Data
(60) Provisional application No. 63/347,058, filed on May 31, 2022.

(51) Int. Cl. B23K 26/362; B41J 2/455; B41J 2/47; B41M 5/26

(52) U.S. Cl. CPC B23K 26/362; B41J 2/455; B41J 2/47; B41M 5/267

(57) ABSTRACT

A system for marking a product is provided. The system comprises: a first laser configured to emit a first beam along a first optical axis, the first beam having a first beam energy density when focused; and a second laser configured to emit a second beam along a second optical axis, the second beam having a second beam energy density when focused; and a beam modulator component configured to adjust at least one of: an angle between the first optical axis of the first beam and the second optical axis of the second beam, a first focusing distance of the first beam, and a second focusing distance of the second beam, such that the first beam energy density and the second beam energy density combined is greater than the threshold energy density sufficient to create the marking.

### FIELD

The present technology broadly relates to systems and methods for printing on products: and in particular, to systems and methods for direct printing on containers produced from molded articles.

### BACKGROUND

Molding is a process by virtue of which an article can be formed from molding material by using a molding system, such as an injection molding process. As one example of a molded article, molding systems could produce a preform that is blow moldable into a container, such as a bottle or the like. Such preforms are typically molded from a thermoplastic such as polyethylene terephthalate (PET) and are otherwise moldable from other thermoplastics such as, for example, high-density polyethylene (HDPE), or polypropylene (PP). Moreover, it is known to mold preforms having a multilayer structure for imparting desired properties to the container blow molded therefrom.

Containers typically include printing for functional and/or decorative purposes. Functional markings may provide, for example, notice to a consumer as to the content of the container (for example, product, volume, best before date, etc.), brand information (for example, vendor name, product trade-name), a source thereof (for example, fabrication or bottling location). Other functional markings may provide machine readable information such as a universal product code (UPC) to facilitate a purchase transaction and/or inventory management. Other functional markings could include markings to denote the type(s) of material used therein to facilitate post-consumer activity such as recycling. Decorative features may include, for example, images, colors, and patterns. Some markings are both decorative and functional with familiar patterns and colors being used to convey brand information.

Such markings are typically printed onto labels and/or sleeves that are then applied to the container. It is also known to mark the container during or after the molding thereof. The markings could include engravings formed in a mold or a post-molding operation using various techniques, such as laser engraving.

Challenges remain for laser markings on molded containers. For example, using the laser may require the container to be immovable during the laser engraving process. If moved, application of a laser beam may not correspond to a desired location of the markings, resulting in some cases in poor legibility or generally inaccurate markings. This may lead to an elevated number of rejected containers or containers being of lower quality.

Certain prior art approaches have been proposed to tackle the above-identified technical problem.

United States Patent Application Publication No.: 2003/0150,847-A1, published on Aug. 14, 2003. assigned to Igor Troitski, entitled “SYSTEM FOR HIGH-SPEED PRODUCTION OF HIGH QUALITY LASER-INDUCED DAMAGE IMAGES INSIDE TRANSPARENT MATERIALS”, discloses a system, which produces the laser-induced damage images by the combination of an electro-optical deflector and means for moving the article or focusing optical system. The combination of the said devices together with using of two laser beams allows increase the image production speed substantially, without the image deterioration. Further, there is disclosed a system for creation of a laser-induced damage by generation of breakdowns at several separate centers by using the computing phase hologram, the phase structure of which is calculated so that the laser beam, passing through the hologram, is focused at several spots.

U.S. Pat. No. 10,583,668-B2, issued on Mar. 10, 2020, assigned to Markem Image Corp., and entitled “SYMBOL GROUPING AND STRIPING FOR WIDE FIELD MATRIX LASER MARKING”, discloses a system including: a laser marking device that directs a laser beam to dwell at different locations to form marks on the products; and a controller that obtains a code to be printed, groups discrete symbols in the code with each other into separate symbol groups based on locations of the discrete symbols in the code, organizes symbol(s) in each respective symbol group into one or more stripes in a direction perpendicular to a direction of motion of the products, adds extra distance or time delay between stripes in at least one of the separate symbol groups to prevent clipping of a symbol by the laser marking device by the laser marking device's print aperture, and causes the laser marking device to direct the laser beam in accordance with the separate symbol groups.

Japanese Patent No.: 5,755,940-B2, issued on Jul. 27, 2015, assigned to KEY TRANDING CO LTD, and entitled “PROCESS FOR PRODUCING PATTERNED BLOW MOLDED ARTICLE AND PATTERNED BLOW MOLDED ARTICLE OBTAINED THEREBY”, discloses a method including: a step of preparing a multilayer blow-molded product where a colored resin layer made of polyolefin resin is formed on the inside and a transparent resin layer made of acrylonitrile-butadiene-styrene resin or ionomer resin is formed on the outside; irradiating laser light from the outside, the laser light passing through the transparent resin layer and reaching the colored resin layer surface, and moving the irradiation position along the colored resin layer surface sequentially, the colored resin layer surface; and a step of revealing a color pattern including a laser beam irradiation locus, wherein the color pattern is shown through the transparent resin layer.

United States Patent Application Publication No.: 2009/0323,753-A1, published on Dec. 31, 2009, assigned to Krones AG, and entitled “APPARATUS FOR INSCRIBING CONTAINERS”, discloses: an apparatus for inscribing containers including an inscription unit. The inscription unit includes a plurality of laser light sources and a plurality of light discharge bodies. The light discharge bodies are arranged next to one another. The laser light sources may be solid-state lasers. Each light discharge body may be connected to a respective one of the laser light sources. The light discharge bodies are configured to direct laser light from the laser light sources onto containers to be inscribed.

United States Patent Application Publication No.: 2011/0089,135-A1, published on Nov. 21, 2011, assigned to AMCOR LIMITED, and entitled “LASER MODIFIED PLASTIC CONTAINER”, discloses a polyethylene terephthalate container having a laser-formed area, wherein the laser-formed area is modified in response to radiation energy. In some embodiments, the laser-formed area of the container permitting localized contouring to permit or otherwise generally prevent flexural response to vacuum and/or loading forces. In some embodiments, the laser-formed area of the container comprises visible indicia formed to permit labeless containers.

### SUMMARY

It is an object of the present technology to address at least some inconveniences associated with the prior art.

Developers of the present technology have appreciated that a number of disadvantages related to laser marking for containers can be reduced if an energy density level of a laser irradiation sufficient for creating the markings on the surface or within a material of the container is attained by combining energy density levels of respective beams of two lasers. More specifically, the developers have devised a system including two lasers that can be arranged in such a way that their beams are both focused in an overlapping focal region matched to a desired region within the material of the container for creating the markings therein.

The lasers are configured to emit the beams whose respective energy density levels taken individually are predetermined, based on the properties of the container material, as being not sufficient to react therewith. The combined energy density in the overlapping focal region, however, is configured to be sufficient for creating the markings in the desired location on or in the container material. Thus, the system disclosed herein is configured to create markings on or in the container material only by simultaneously applying, to the desired location, both respective beams of the lasers, each beam being individually configured not to interact with the material of the container.

Thus, non-limiting embodiments of the present technology allow improvement of the accuracy of laser markings for containers, such as in cases when the container is being moved relative to the system, thereby reducing chances of the container being rejected due to quality issues.

In another example, the container may be produced from a recycled plastic material and/or include certain quality improving additives which may result in the container having solid inclusions (impurities) that can be reactive to a certain energy density level of the laser irradiation. Thus, by keeping the energy density level of the individual beam lower than a threshold energy density attained by combining both beams, as disclosed herein, undesired markings within regions of such impurities can be prevented.

Thus, the non-limiting embodiments of the present technology allow for improved effectiveness of container labelling processes.

It should be noted that the system described herein is not limited to containers having been produced from molded articles, and can be applied to other products whose materials are reactive to laser irradiation, fast-moving consumer goods and packaging material thereof, and the like.

More specifically, in accordance with a first broad aspect of the present technology, there is provided a system for marking a product. The product includes a markable region in which a marking can be created by incident irradiation having an energy above a threshold energy. The system comprises: a first laser configured to emit a first beam along a first optical axis, the first beam having a first beam energy density when focused which is less than the threshold energy density: and a second laser configured to emit a second beam along a second optical axis, the second beam having a second beam energy density when focused which is less than the threshold energy density, wherein the first optical axis and the second optical axis are arranged to transect in an overlapping focal region: at least one beam modulator component configured to adjust at least one of: an angle between the first optical axis of the first beam and the second optical axis of the second beam, a first focusing distance of the first beam, and a second focusing distance of the second beam, such that: the overlapping focal region of the first beam and the second beam is formed at a given location in the markable region of the product, and the first beam energy density and the second beam energy density combined is greater than the threshold energy density sufficient to create the marking.

In some embodiments of the system, the system is configured to create the markings on a surface of the markable region.

In some embodiments of the system, the system is configured to create the markings within the markable region.

The system of claim 1, wherein the first laser and the second laser are configured to cause at least one of a physical change and a chemical reaction at the given location in the markable region of the product.

In some embodiments of the system, each one of the first laser and the second laser are of a first laser type causing carbonization to the given location of the markable region to create the marking therein.

In some embodiments of the system, each one of the first laser and the second laser are of a second laser type causing foaming to the given location of the markable region to create the marking therein.

In some embodiments of the system, the first laser and the second laser are chosen from a first laser type and a second laser type: and the first laser type is configured to emit irradiation of a longer wavelength than that emitted by the second laser type.

In some embodiments of the system, the first laser type comprises a carbon dioxide laser; and the second laser type comprises a Near-Infrared (NIR) laser.

In some embodiments of the system, the system is configured to mark the product having a material which is generally unreactive to irradiation having an energy lower than the threshold energy.

In some embodiments of the system, the system is configured to mark the product having a layered structure including: an outer skin layer: at least one middle layer; and an inner skin layer.

In some embodiments of the system, each one of the layered structure has been produced from a thermoplastic material.

In some embodiments of the system, the thermoplastic material is one of polyethylene terephthalate, high-density polyethylene, or polypropylene.

In some embodiments of the system, one of the outer skin layer, the at least one middle layer, and the inner skin layer comprises a printing layer of the product where the marking region is defined for creating the marking therein.

In some embodiments of the system, the at least one beam modulator component is configured to form the overlapping focal region of a smaller depth than that of the printing layer.

In some embodiments of the system, the printing layer includes an additive sensitive to irradiation having the energy above the threshold energy density.

In some embodiments of the system, the product is a container having been produced from a molded article.

In some embodiments of the system, the first optical axis is non-parallel to the second optical axis.

In some embodiments of the system, the first optical axis is arranged at an acute angle to the second optical axis.

In some embodiments of the system, the first optical axis and the second optical axis are arranged at equal angles to a normal of the markable region of the product.

In the context of the present specification, the words “first”, “second”, “third”, etc. have been used as adjectives only for the purpose of allowing for distinction between the nouns that they modify from one another, and not for the purpose of describing any particular relationship between those nouns. Further, as is discussed herein in other contexts, reference to a “first” element and a “second” element does not preclude the two elements from being the same actual real-world element.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

The detailed description of illustrative (non-limiting) embodiments will be more fully appreciated when taken in conjunction with the accompanying drawings, in which:

FIG. 1 depicts a flow diagram of a process for producing molded products, in accordance with certain non-limiting embodiments of the present technology;

FIG. 2 depicts a schematic diagram of a molding system configured for producing molded articles, in accordance with certain non-limiting embodiments of the present technology;

FIG. 3A depicts an example molded article that is moldable in a mold of the molding system of FIG. 1, the molded article being configured as a preform of the type that is blow moldable to form a container, in accordance with certain non-limiting embodiments of the present technology;

FIG. 3B depicts an enlarged view of a wall portion of the molded article, preform, as indicated in FIG. 3A, in accordance with certain non-limiting embodiments of the present technology;

FIG. 3C depicts an example container molded from the preform depicted in FIG. 3A, in accordance with certain non-limiting embodiments of the present technology;

FIG. 3D depicts an enlarged view of a wall portion of the container as indicated in FIG. 3C, in accordance with certain non-limiting embodiments of the present technology;

FIGS. 4A and 4B depict a schematic diagram of a printing procedure for printing onto the container of FIG. 3C, in accordance with certain non-limiting embodiments of the present technology;

FIG. 5 depicts a schematic diagram of a printing system configured for executing the container printing procedure as indicated in FIGS. 4A and 4B, in accordance with certain non-limiting embodiments of the present technology;

FIGS. 6A and 6B depict cross-sectional and lateral views, respectively, of an overlapping focal region formed by the printing system of FIG. 5 for executing the container printing procedure as indicated in FIGS. 4A and 4B, in accordance with certain non-limiting embodiments of the present technology;

FIGS. 7A and 7B depict schematic diagrams of different fashion of applying, by the printing system of FIG. 5, markings within a given layer the container of FIG. 3C during executing the container printing procedure as indicated in FIGS. 4A and 4B, in accordance with certain non-limiting embodiments of the present technology; and

FIGS. 8A and 8B depict schematic diagrams of applying, by the printing system of FIG. 5, the markings as depicted in FIGS. 7A and 7B within an other layer of the container of FIG. 3C during executing the container printing procedure as indicated in FIGS. 4A and 4B, in accordance with certain non-limiting embodiments of the present technology.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified embodiments of the present technology. As persons skilled in the art would understand, various embodiments of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and embodiments of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

With these fundamentals in place, we will now consider some non-limiting examples to illustrate various embodiments of aspects of the present technology.

### Production Process Overview

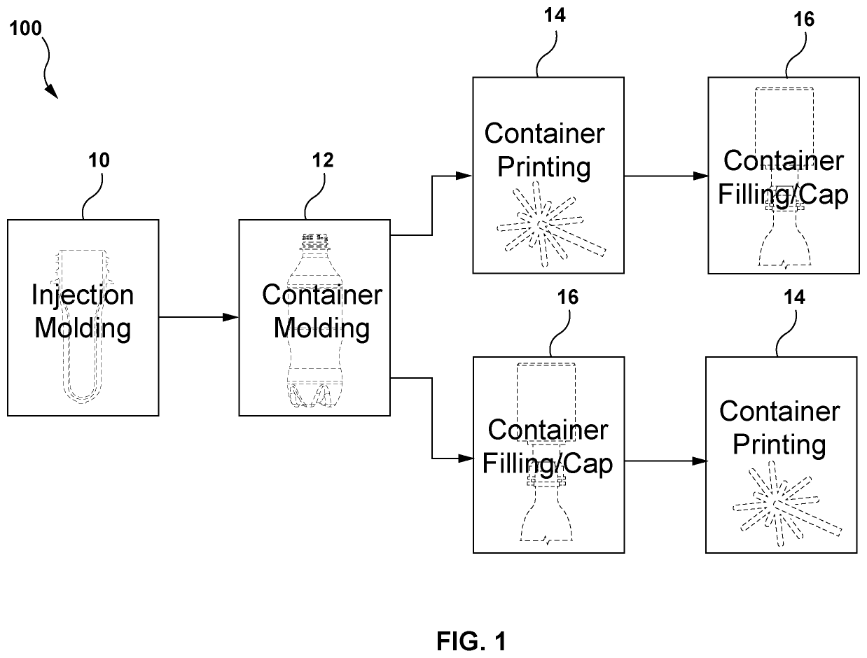

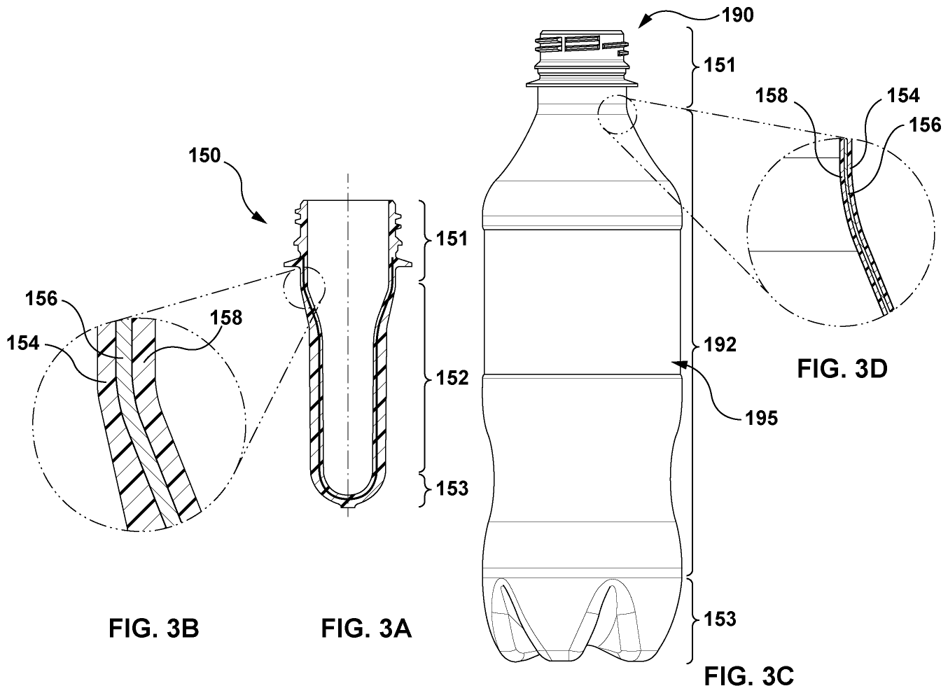

With reference to FIG. 1, there is depicted a schematic diagram of a process 100 for producing packaged products, including molding, forming, filling/capping and printing of a completed container, such as a container 190 depicted in FIG. 3C, in accordance with certain non-limiting embodiments of the present technology.

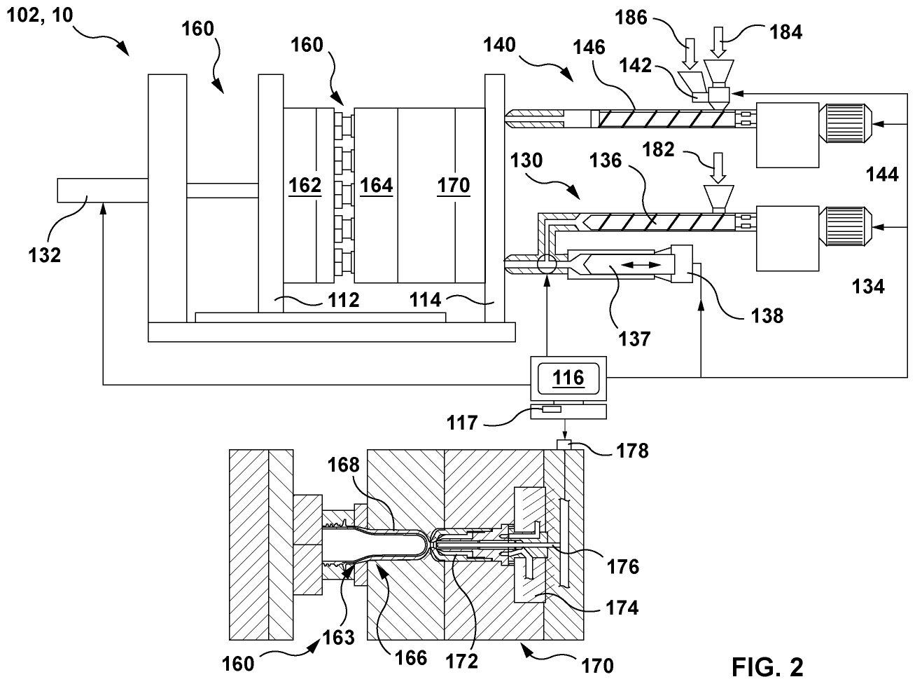

As best shown in FIG. 1, the process 100 includes certain procedures directed to producing the container 190. The process 100 includes an injection molding procedure 10 for producing a molded article, such as a molded article 150 depicted in FIG. 3A, from which the container 190 can be produced. According to certain non-limiting embodiments of the present technology, the molded article 150 can be produced by a molding system 102 described hereinbelow with reference to FIG. 2.

Further, the process 100 includes a container molding procedure 12 for forming, from the molded article 150, the container 190. According to certain non-limiting embodiments of the present technology, the container molding procedure 12 can be executed by a forming system (not depicted). Broadly speaking, the forming system can be configured to: (i) obtain the molded article 150, such as from the molding system 102; (ii) clamp the molded article 150 in a container mold representative of a desired form to be given to the container 190; and (iii) inject, typically under high pressure, an inflating agent (such as air or liquid, as an example) into the molded article 150, thereby causing walls of the molded article 150 to stretch out and match the form of the container mold. This process is generally referred to as blow-molding. Additionally, the forming system could be configured to cool down the container 190 thus produced in the container mold until the material thereof is sufficiently hardened. It should be expressly understood that other configurations of the forming system are envisioned without departing from the scope of the present technology, such as those configured for extrusion molding, compression molding, injection-compression molding, blow-trim molding of the molded article 150, and the like.

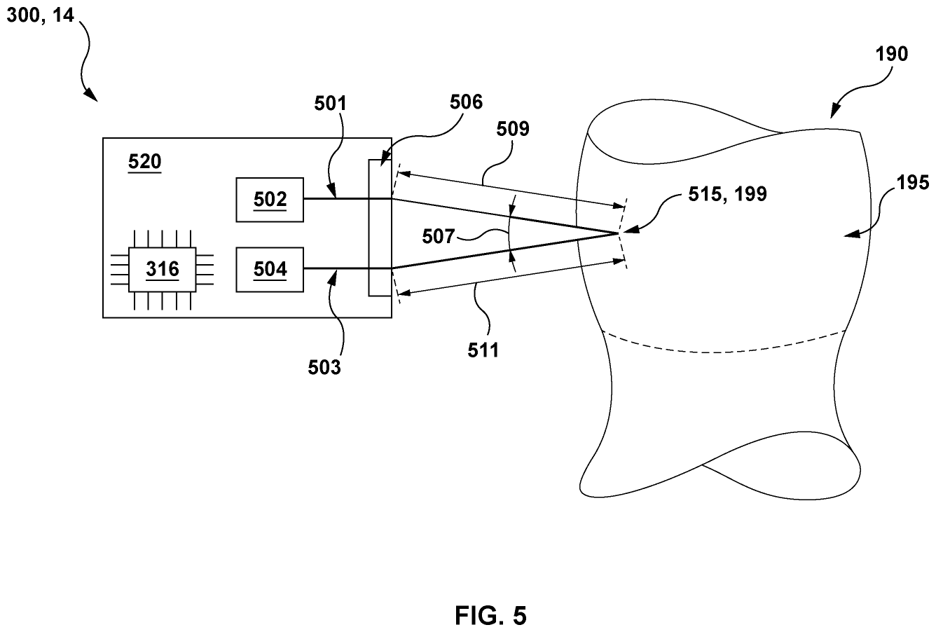

Further, the process 100 includes a container printing procedure 14 for printing markings on the container 190, which can include various decorative and functional markings. The markings could include, but are not limited to, a brand image, logo, a product name, and a UPC code. According to certain non-limiting embodiments of the present technology, the container printing procedure 14 can be executed directly on the container 190, by selective irradiation of one or more points of the container 190. For example, the container printing procedure 14 can be executed by a printing system 300 described herein below with reference to FIG. 5.

Further, the process 100 includes a container filling and capping procedure 16 for filling the container 190 with a packaged product, such as a beverage, and capping the container 190. According to certain non-limiting embodiments of the present technology, the container filling and capping procedure 16 can be executed by a filling and capping system (not depicted). Broadly speaking, the filling and capping system can be configured to dose the product in the container 190 according to a volume thereof and further put a cap on an open end of the container 190 to securely encapsulate the packaged product in the container 190.

As it can be appreciated form FIG. 1, in some non-limiting embodiments of the present technology, the container printing procedure 14 could be executed prior to the container filling and capping procedure 16. In other non-limiting embodiments of the present technology, the container printing procedure 14 could be executed after the container filling and capping procedure 16.

### Injection Molding Procedure

With reference to FIG. 2, there is depicted a schematic representation of a molding system 102, in accordance with certain non-limiting embodiments of the present technology, configurable for executing the injection molding procedure 10. The molding system 102 is configured as an injection molding system that is capable of molding molded articles, such as the molded article 150 depicted in FIG. 3A and mentioned above. In the illustrated non-limiting embodiment, the molded article 150 is a multilayer preform of the type that is re-moldable, at least in part by blow molding or liquid molding, for example, into the container 190 as depicted in FIG. 3C.

According to certain non-limiting embodiments of the present technology, the molding system 102 includes a clamp 110, an injection unit 130, an auxiliary injection unit 140, a mold 160, and a controller 116.

In some non-limiting embodiments of the present technology, the clamp 110 includes a stationary platen 114 and a moveable platen 112 that are supported on a base (not separately labelled). In operation, the moveable platen 112 is moveable relative to the stationary platen 114 by means of a clamp actuator 132 for opening, closing and otherwise clamping the mold 160. The clamp actuator 132 is communicatively coupled to the controller 116 whereby the controller 116 is able to control the operation thereof.

In some non-limiting embodiments of the present technology, the injection unit 130 includes, amongst other things, a plasticizer 136 and a separate shooting pot 137. As such the injection unit 130 is configured as a so-called two-stage injection unit that is capable of plasticizing during injection. The plasticizer 136 is operated by a plasticizing actuator 134 for plasticizing a first thermoplastic material 182 therein. The shooting pot 137 is operated by an injection actuator 138 for injecting the first thermoplastic material 182 into a hot runner 170 of the mold 160. The plasticizing actuator 134 and the injection actuator 138 are connected to the controller 116 whereby the controller is able to control the operation thereof.

The composition of the first thermoplastic material 182 is not particularly limited. Thus, in some non-limiting embodiments of the present technology, the first thermoplastic material 182 could include but is not limited to polyethylene terephthalate, high-density polyethylene, and polypropylene.

Likewise, in some non-limiting embodiments of the present technology, the auxiliary injection unit 140 includes, amongst other things, an auxiliary plasticizer 146 and an auxiliary plasticizing actuator 144. The auxiliary injection unit 140 is configured as a reciprocating screw type injection unit. The auxiliary plasticizer 146 is operated by the auxiliary plasticizing actuator 144 for plasticizing and injecting a second thermoplastic material 184 into the hot runner 170 of the mold 160.

In some non-limiting embodiments of the present technology, the composition of the second thermoplastic material 184 can be similar to that of the first thermoplastic material 182, such as one of polyethylene terephthalate, high-density polyethylene, and polypropylene. However, in other non-limiting embodiments of the present technology, the second thermoplastic material 184 can be different from the first thermoplastic material 182. Such composites could be included to impart certain desirable properties, for example, improved barrier resistance to the migration of gas and moisture through a wall of the container. To that end, the second thermoplastic material 184 could include nylon, PolyGlycolide Acid (PGA), and Ethylene Vinyl Alcohol (EVOH), amongst many others. In vet other non-limiting embodiments of the present technology, the second thermoplastic material 184 could include composites unstable in contact with water (that is, soluble and/or degradable) such as a water-soluble polymer or a hydro-degradable polymer. For example, water-soluble polymers may include ethylene vinyl alcohol, poly vinyl alcohol, poly ethylene glycol, dextrans, pullulan, poly vinyl pyrrolidone, poly acrylic acid, poly acrylamide, poly oxazoline, poly phosphates or cellulose. Further, hydro-degradable polymers may include one of PGA, sugar/polysaccharide starch, polyglycolide, polycaprolactone, poly lactic acid, and polyhydroxyalkanoates. A technical effect of the foregoing may include improved recyclability of the container 190 produced using the second thermoplastic material 184.

Further, in some non-limiting embodiments of the present technology, the first thermoplastic material 182 and/or the second thermoplastic material 184 could be intrinsically photo-sensitive, that is, without using special photo-sensitive additives therein, such that their visual appearance changes upon exposure to light irradiation. The change of visual appearance or the degree of changes imparted could depend on various properties of the materials 182, 184 and/or the light source, such as an energy density level and/or wavelength of the incident light.

However, according to certain non-limiting embodiments of the present technology, photo-sensitive properties can be provided to either one or both of the first thermoplastic material 182 and the second thermoplastic material 184 by adding thereto a photo-sensitive additive. In the illustrated embodiment, a photo-sensitive additive 186 is added to the second thermoplastic material 184. It is contemplated that the photo-sensitive additive 186, or a different photo-sensitive additive, could be alternatively or additionally added to the first thermoplastic material 182. To that end, as further depicted in FIG. 1, the auxiliary injection unit 140 further includes a blender device 142 at an inlet thereof, also referred to as a dosing device. The blender device 142 is configured to blend or otherwise dose a flow of the second thermoplastic material 184 and the photo-sensitive additive 186. The auxiliary plasticizing actuator 144 and the blender device 142 can thus be connected to the controller 116 whereby the controller 116 is able to control the operation thereof.

Broadly speaking, the photo-sensitive additive 186 is an additive configured for increasing sensitivity of the second thermoplastics material 184 to incident light having the energy density value greater than a threshold energy density value. The photo-sensitive additive 186 increases the sensitivity of the second thermoplastic material 184 such that, under laser irradiation of the energy density value greater than the threshold energy density value, for example, the second thermoplastic material 184 changes its reflective and/or transmissive properties, changing the visual appearance of the irradiated portions of the second thermoplastics material 184. Depending on the specific embodiment, irradiation of portions of the second thermoplastics material 184 causes a physical change or chemical reaction. For example, in some embodiments, irradiation of portions of the second thermoplastics material 184 causes either carbonization traces or foaming therein, depending on the material or the particular additive 186 (described in greater detail below). At the same time, at least one of a source of the laser irradiation (such as one of the a first laser 502 and a second laser 504 described below with reference to FIG. 5) and the first thermoplastic material 182 can be selected such that the first thermoplastic material 182 is unreactive to the laser irradiation of the energy density value greater than the threshold energy density value.

In a specific non-limiting example, the photo-sensitive additive 186 can be a photo-sensitive additive of one of types available from DATALASE LTD. of Unit 3, Wheldon Road, Widnes, Cheshire, WA8 8FW, United Kingdom. It should be noted that any other suitable photo-sensitive additives can be used.

It should be noted that, in other non-limiting embodiments of the present technology, the blender device 142 could be disposed at an inlet of the auxiliary injection unit 140 for adding the photo-sensitive additive 186 to the first thermoplastic material 182. In vet other non-limiting embodiments of the present technology, the molding system 102 could include an auxiliary blender device (not depicted) disposed at an inlet of the injection unit 130 for adding the photo-sensitive additive 186 to both the first thermoplastic material 182 and the second thermoplastic material 184.

Further, in some non-limiting embodiments of the present technology, the mold 160 includes, amongst other things, a moveable part 163 and a stationary part 164 that may be arranged in a closed configuration, as shown, to define a molding cavity 168 therebetween and otherwise arranged in an open configuration, not shown, for removing/ejecting the molded article 150 therefrom. Accordingly, the moveable part 163 is coupled to the moveable platen 112 of the clamp 110 whereas the stationary part 164 is coupled to the stationary platen 114 via a hot runner 170 that is disposed therebetween. The molding cavity 168 is defined by a mold stack 166 that includes a set of complimentary inserts that are arranged in the moveable and stationary parts of the mold 160. For purposes of a conceptual depiction of the mold 160 only one mold stack 166 is shown whereas in practice the mold 160 is likely to include a plurality thereof.

Further, in some non-limiting embodiments of the present technology, the hot runner 170 is configured to fluidly connect the injection unit 130 and the auxiliary injection unit 140 with the molding cavity 168. As will be appreciated by a person skilled in the art, the hot runner 170 is typical in that it includes a nozzle 172, a manifold 174 and a nozzle valve assembly 176. The manifold 174 is arranged to connect the outlets of each one of the injection unit 130 and the auxiliary injection unit 140 with inlets of the nozzle 172. The nozzle 172 is configured to split an inlet flow of the first thermoplastic material 182 received from the injection unit 130, via the manifold 174, in a melted state and to direct the resulting flows towards inner and outer skin outlets (not numbered). The nozzle 172 is similarly configured to receive an inlet flow of the second thermoplastic material 184 with the photo-sensitive additive 186 entrained therein, received from the auxiliary injection unit 140, via the manifold 174, in a melted state and to direct the resulting flow towards an intermediate outlet (not numbered) that is arranged between the skin outlet channels. The nozzle valve assembly 176 includes a valve actuator 178 that is connected to the controller whereby the controller is able to control the operation thereof. Through coordinated control, by the controller 116, of the injection unit 130, the auxiliary injection unit 140 and the nozzle valve assembly 176, amongst other controllable devices, injecting of the first thermoplastic material 182 and the second thermoplastic material 184 through selected outlets of the nozzle 172 and into the molding cavity 168 may be performed sequentially and/or simultaneously.

Within various non-limiting embodiments of the present technology, the controller 116 can be implemented as a computing apparatus having a processor (not separately numbered). The processor may be provided through the use of dedicated hardware as well as hardware capable of executing software in association with appropriate software. The processor can execute one or more functions to control operations of one or more of the components of the molding system 102. When provided by a processor, the functions may be provided by a single dedicated processor, by a single shared processor, or by a plurality of individual processors, some of which may be shared. In some embodiments of the present technology, the processor may be a general-purpose processor, such as a central processing unit (CPU) or a processor dedicated to a specific purpose. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included. The controller 116 has access to a memory (not depicted) that stores computer executable instructions 117, which computer executable instructions 117, when executed, cause the processor of the controller 116 to control operation of one or more of the components of the molding system 102 as described above.

The injection molding procedure 10 hence terminates.

### Container Molding Procedure

According to certain non-limiting embodiments of the present technology, the process 100 continues with the container molding procedure 12 where the forming system (not depicted), as described above with reference to FIG. 1, can be configured to execute the container molding procedure 12 for producing the container 190 from the molded article 150.

With reference to FIG. 3A to 3D, there are depicted schematic diagrams of the molded article 150 (the preform 150) and the container 190 formed therefrom as introduced above, in accordance with certain non-limiting embodiments of the present technology.

As best shown in FIG. 3A, the preform 150 includes a body configurable to define a storage vessel of the container 190. The preform body is generally tubular with a neck portion 151 at an open end, a base portion 153 at a closed end and a body portion 152 defined therebetween. The body portion 152 and the base portion 153 are re-moldable to provide a container body portion 192 and a container base portion 193 of the container 190, respectively. The neck portion 151 of the molded article 150 is configured to define a container neck portion 191 of the container 190.

The container neck portion 191 is configured to be capped, such as by the filling and capping system described above, using a closure to enclose a volume defined within the container 190. In other embodiments, not shown, the molded article 150 may define a finished container ready to be filled and capped (that is, it does not require any post molding transformation through blow molding, liquid molding, or the like).

As is briefly described above, the molded article 150 can be formed with a layered structure by the molding system 102. More specifically, in some non-limiting embodiments of the present technology, each one of the neck portion 151, the body portion 152, and the base portion 153 of the molded article 150 may have multiple layers including, for example, an inner skin layer 154, at least one middle layer 156, and an outer skin layer 158. In the illustrated example, the inner skin layer 154 and the outer skin layer 158 are formed from the first thermoplastic material 182, and the at least one middle layer 156 is formed from the second thermoplastic material 184. A different arrangement of the materials 182, 184 is contemplated in different embodiments.

Also, it should be noted that while producing the container 190 from the molded article 150, the forming system can be configured to preserve the layered structure of the preform 150 in the container 190. As is illustrated, the container 190 has the inner skin layer 154, the at least one middle layer 156, and the outer skin layer 158 corresponding to those of the preform 150.

However, in other non-limiting embodiments of the present technology, the molded article 150, and hence the container 190 produced therefrom, may not define different layers therewithin and can include a single layer (and thus are referred to herein as “monolayer” articles) formed from one of the first thermoplastic material 182 and the second thermoplastic material 184, as described above.

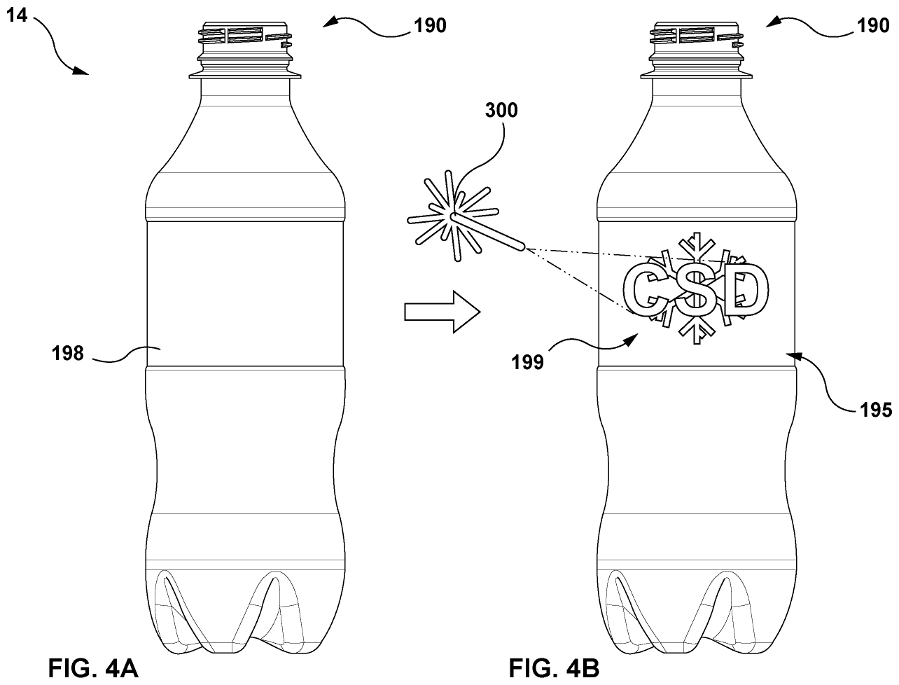

According to certain non-limiting embodiments of the present technology, one of the inner skin layer 154, the at least one middle layer 156, and the outer skin layer 158 of the container 190 can be configured to be a printing layer, in which a markable region 195 of the container 190 can be defined for creating markings therein, as will be described below with reference to FIGS. 4 to 6.

However, it should be noted that, in other non-limiting embodiments of the present technology, where the container 190 is a monolayer container, that is, defines only a single layer of one of the materials 182, 184, the printing layer and thus the markable region 195 can extend through an entire depth of a wall of the container 190.

As described above with respect to the first thermoplastic material 182 and the second thermoplastic material 184, the printing layer can be photo-sensitive such that its visual properties (for example, opacity, color, etc.) are changed (that is, developed) on exposure to the laser irradiation of selected properties (that is, wavelength, energy density value, etc.). As such, in some non-limiting embodiments of the present technology, the one of the inner skin layer 154, the at least one middle layer 156, and the outer skin layer 158 of the container 190 having been determined as being the printing layer can be intrinsically photo-sensitive. In the present example, desired photo-sensitive properties are added or enhanced in the markable region 195 using the photo-sensitive additive 186 mentioned above.

It should be noted that the markable region 195 defined within the container body portion 192 as depicted in FIG. 3C (see also FIG. 4B) is provided for illustrative purposes only and not as a limitation: and in various non-limiting embodiments of the present technology, other configurations of the markable region 195 are envisioned, such as those defined in other portions of the container 190, that is, the container base portion 193 or the container neck portion 191, or corresponding to an entirety of an area thereof, for example extending along an entirety of the printing layer.

Thus, according to certain non-limiting embodiments of the present technology, the container 190 can have one or more printing layers, selected from one or more of the inner skin layer 154, the at least one middle layer 156, and the outer skin layer 158, sensitive (or otherwise reactive) to light irradiation having an energy density level greater the threshold energy density value. In other words, the printing layer can be configured for changing its visual appearance upon exposure to the irradiation, such as from a laser, of having an energy density level greater than the threshold energy density value.

Thus, after the container molding procedure 12 resulted in producing the container 190 having at least one printing layer, the process 100 advances to the container printing procedure 14 where the printing system 300 is configured to print the markings on the printing layer.

### Printing Procedure

With reference to FIGS. 4A and 4B there is depicted a schematic diagram of the container printing procedure 14 executed by the printing system 300 for producing the markings on the container 190, such as container markings 199, in accordance with certain non-limiting embodiments of the present technology. As it can be appreciated, the container 190 depicted in FIG. 4A is prior to executing the container printing procedure 14: whereas the container 190 as depicted in FIG. 4B is post-printing, including the container markings 199.

With additional reference to FIG. 5, there is schematically depicted a functional diagram of the printing system 300 configured for creating the container markings 199 within the markable region 195 defined in the printing layer of the container 190, in accordance with certain non-limiting embodiments of the present technology.

Broadly speaking, the printing system 300 includes a variety of internal components including, without limitation: (1) a first laser 502 configured to emit, along a first optical axis, a first beam 501; (2) a second laser 504 configured to emit, along a second optical axis, a second beam 503; (3) a beam modulation component 506; and (4) a printing system controller 316.

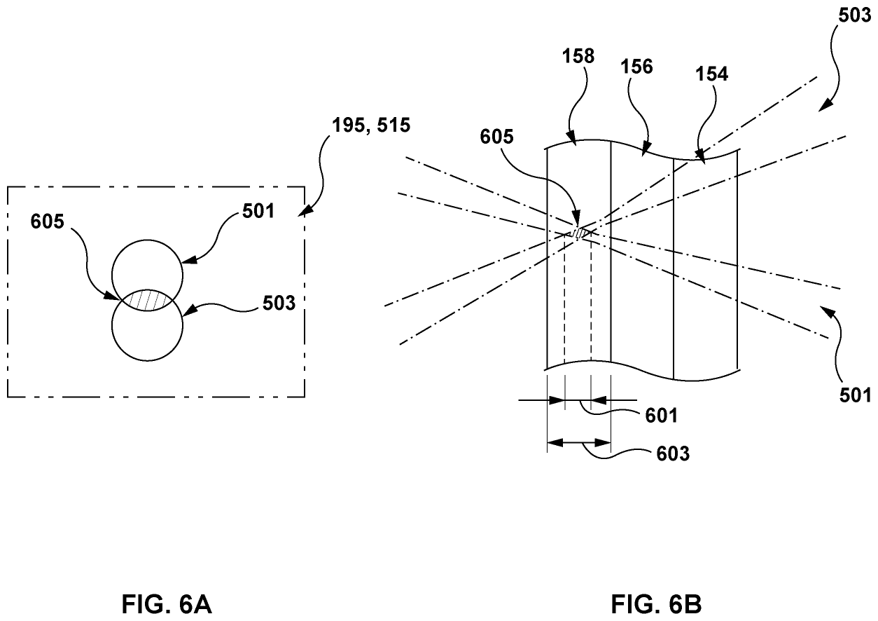

Broadly speaking, the printing system 300 operates as follows: the beam modulation component 506 is configured to focus the first beam 501 and the second beam 503 and further cause the first optical axis and the second optical axis thereof to intersect in an overlapping focal region (such as an overlapping focal region 605 depicted in FIGS. 6A and 6B), thereby combining respective energy density values of the first beam 501 and the second beam 503 focused therein. Accordingly, the first laser 502 and the second laser 504 can be configured such that a combined energy density value of the first beam 501 and the second beam 503 in the overlapping focal region 605 would be greater than the threshold energy density associated with the printing layer. Thus, by modulating a location of the overlapping focal region 605 formed by the first beam 501 and the second beam 503 along a surface of the markable region 195 or through a depth thereof, as will be described below, the printing system 300 can be configured for creating the container markings 199 therein. In at least embodiments, it is contemplated that the printing system 300 could be provided with two beam modulation components, one for each laser 502, 504.

According to certain non-limiting embodiments of the present technology, the beam modulation component 506 is configured for steering each one of the first beam 501 and the second beam 503 and focusing them for forming the overlapping focal region 605. The beam modulation component 506 is communicatively coupled to the printing system controller 316, whereby the printing system controller 316 can be configured to control the operation of the beam modulation component 506.

As mentioned above, according to certain non-limiting embodiments of the present technology, the container markings 199 can include functional markings and decorative markings, such as, without limitations, a brand image/logo, a product name, product information, a bar and/or Quick Response (QR) code, and the like.

In certain non-limiting embodiments of the present technology, one or more of the internal components of the printing system 300 are disposed in a common housing 520 as depicted in FIG. 5. In some embodiments of the present technology, the printing system controller 316 could be located outside of the common housing 520 and communicatively connected to the components thereof. As it can be appreciated, the printing system controller 316 can be implemented similarly to the controller 116 of the molding system 102 described above.

According to certain non-limiting embodiments of the present technology, each one of the first laser 502 and the second laser 504 is communicatively coupled to the printing system controller 316. In certain non-limiting embodiments of the present technology, each one of the first laser 502 and the second laser 504 are pre-configured for operation at a respective operating wavelength. The respective operating wavelength of a given one of the first laser 502 and the second laser 504 may be in the infrared, visible, and/or ultraviolet portions of the electromagnetic spectrum. For example, each one of the first laser 502 and the second laser 504 may include at least one laser with an operating wavelength between about 650 nm and 1150 nm. Alternatively, a given one of the first laser 502 and the second laser 504 may include a laser diode configured to emit light at a wavelength between about 800 nm and about 1000 nm, between about 850 nm and about 950 nm, or between about 1300 nm and about 1600 nm. In yet another example, each one of the first laser 502 and the second laser 504 can be configured to emit laser irradiation at the respective operating wavelength between about 2000 nm and about 3500 nm, or between about 4000 nm and between about 8000 nm. In yet another example, the respective operating wavelength of each one of the first laser 502 and the second laser 504 can be between about 8000 nm and 10600 nm.

According to certain non-limiting embodiments of the present technology, each one of the first laser 502 and the second laser 504 includes a pulsed laser configured to produce, emit, or radiate pulses of light with a certain pulse duration. For example, in some non-limiting embodiments of the present technology, each one of the first laser 502 and the second laser 504 may be configured to emit pulses with a pulse duration (for example, pulse width) ranging from 10 ps to 100 ns. In other non-limiting embodiments of the present technology, each one of the first laser 502 and the second laser 504 may be configured to emit pulses at a pulse repetition frequency of approximately 100 kHz to 5 MHz or a pulse period (for example,, a time between consecutive pulses) of approximately 200 ns to 10 μs. Overall, however, each one of the first laser 502 and the second laser 504 can generate the first beam 501 and the second beam 503, respectively, having pulses of any suitable energy, any suitable average optical power, or peak optical power for a given application.

In other non-limiting embodiments, each one of the first laser 502 and the second laser 504 could be implemented as a continuous-wave laser without departing from the scope of the present technology. In other words, in these embodiments each one of the first laser 502 and the second laser 504 could be configured to emit a respective one of the first beam 501 and the second beam 503 being a continuous uninterrupted beam of light of the respective operating wavelength and any suitable average power. In some non-limiting embodiments of the present technology, each one of the first beam 501 and the second beam 503 may have a substantially circular cross-section.

It is also contemplated that each one of the first beam 501 and the second beam 503 could be unpolarized or randomly polarized, could have no specific or fixed polarization (for example, the polarization may vary with time), or could have a particular polarization (for example, a given one of the first beam 501 and the second beam 503 can be linearly polarized, elliptically polarized, or circularly polarized).

Thus, in some non-limiting embodiments of the present technology, each one of the first laser 502 and the second laser 504 is configured to emit the respective one of the first beam 501 and the second beam 503. When focused, by the beam modulation component 506, the beams 501, 503 form the overlapping focal region 605. Outside of the overlapping focal region 605, each beam 501, 503 has a respective beam energy density value that is lower than the threshold energy density value associated with the printing layer of the container 190. However, when combined in the overlapping focal region 605, the beams 501, 503 have a combined energy density value equal to or greater than the threshold energy density value. In other words, in the illustrated embodiments, the materials 182, 184 of the markable region 195 are not reactive to any individual one of the first beam 501 and the second beam 503 passing therethrough. When the first beam 501 and the second beam 503 are focused on one or more points within the markable region 195, the combined energy density value of the beams 501, 503 is greater than the threshold energy density value and is thus sufficient to cause the one or more points to change in visual appearance, for example, at a given location 515 of the markable region 195 defined therein.

Further, in some non-limiting embodiments of the present technology, each one of the first laser 502 and the second laser 504 can be configured to operate at a same operating wavelength. For example, each one of the first laser 502 and the second laser 504 can be of a first laser type having a first operating wavelength. According to certain non-limiting embodiments of the present technology, the first operating wavelength can be predetermined such that laser irradiation thereof having the energy density value equal to or greater than the threshold energy density value applied to the printing layer causes carbonization thereto, which can be used for creating the container markings 199 therein.

In the context of the present specification, the term “carbonization” of a material, such as that of one or more of the layers of the markable region 195, denotes partial oxidation of hydrocarbon thereof due to rupturing chemical bonds between molecules of the material by laser irradiation having a certain minimum energy density value. As a result, the oxidized hydrocarbon forms discoloration in the printing layer ranging from gray to black.

Further, in other non-limiting embodiments of the present technology, each one of the first laser 502 and the second laser 504 could be of a second laser type having a second operating wavelength, different from the first operating wavelength. According to certain non-limiting embodiments of the present technology, the second operating wavelength can be predetermined such that laser irradiation thereof having the energy density value equal to or greater than the threshold energy density value associated with the one or more of the layers of the markable region 195 when applied causes foaming therein, which can be used for creating the container markings 199 therein.

In the context of the present specification, the term “foaming” of the material, such as that in the markable region 195, refers to melting thereof by the laser irradiation resulting in oxidizing carbon of the material forming carbon dioxide which further emerges as bubbles on the surface of the material. Foaming results in a coloration of the thermoplastic material (such as the materials 182, 184) appearing light gray to white at points receiving irradiation above the threshold.

Further, according to certain non-limiting embodiments of the present technology, the first operating wavelength of the first laser type could be longer than the second operating wavelength of the second laser type. In a specific non-limiting example, the first laser type could include a carbon dioxide laser with an operating wavelength of around 10600 nm. The second laser type could include a Near-Infrared (NIR) laser with an operating wavelength from around 750 nm to around 1400 nm. In another example, the first laser type could be a fiber laser with an operating wavelength from around 1064 nm to around 2100 nm: and the second laser can be an ultraviolet (UV) laser, such as one of ArF, KrF, XeF, or XeCl lasers, providing laser irradiation of an operating wavelength from around 250 nm to around 350 nm. However, it should be expressly understood that other suitable lasers can be used for causing the above-described discoloration effects in the printing layer of the container 190.

As is mentioned above, the beam modulation component 506 steers the beams 501, 503 to form the overlapping focal region 605. In some non-limiting embodiments of the present technology, the beam modulation component 506 could include a pair of lenses (not depicted). Broadly speaking, a given lens of the pair of lenses is configured for converging an input light flow of a respective one of the first beam 501 and the second beam 503 in the respective focal region thereof at a respective focusing distance.

For example, a first lens of the pair of lenses can be configured for focusing the first beam 501 in a first focal region positioned at a first focusing distance 509 therefrom. Further, a second lens of the pair of lenses can be configured for focusing the second beam 503 in a second focal region positioned at a second focusing distance 511 therefrom.

In some non-limiting embodiments of the present technology, a given one of the pair of focus lenses can be configured for providing a respective one of the first focusing distance 509 and the second focusing distance 511 being one of 1.5 inch, 2.0 inch, 3.0 inch, and 4.0 inch, as an example.

However, in other non-limiting embodiments of the present technology, the given focus lens could include a lens system configured for focusing the respective one of the first beam 501 and the second beam 503 at a plurality of focusing distances from the lasers 502, 504, for example at 1.5 inch, 2.0 inch, 3.0 inch, and 4.0 inch. In another example, the lens system could be configured for smooth adjustment of the focusing distance within a predetermined range of distances, from 1.5 inch to 4.0 inch for example. To that end, the lens system could be communicatively coupled to one or more actuators (further coupled to the printing system controller 316) configured to move or adjust the lens system for providing a desired focusing distance from the lens system.

In certain non-limiting embodiments of the present technology, the beam modulation component 506 may further include a variety of other optical components and/or mechanical-type components for performing the steering and focusing the given one of the first beam 501 and the second beam 503. For example, the beam modulation component 506 may include one or more mirrors, prisms, lenses, MEM components, piezoelectric components, optical fibers, splitters, diffractive elements, collimating elements, and the like. It should be noted that the beam modulation component 506 may also include one or more additional actuators (not separately depicted) driving at least some of the other optical components to rotate, tilt, pivot, or move in an angular manner about one or more axes, for example.

It is not limited how a given one of the first focusing distance 509 and the second focusing distance 511 is selected for focusing a respective one of the first beam 501 and the second beam 503 thereat; and in some non-limiting embodiments of the present technology, can depend on a depth of a respective one of the first focal region and the second focal region. For example, as will become apparent from the description provided below, the given one of the first focusing distance 509 and the second focusing distance 511 can be predetermined such that the depth of the respective one of the first focal region and the second focal region is no greater than a depth of the printing layer-such as a printing layer depth 603 depicted in FIG. 6B.

Thus, in some non-limiting embodiments of the present technology, for forming the overlapping focal region 605, the printing system controller 316 can be configured to cause the beam modulation component 506 to arrange the first optical axis of the first beam 501 and the second optical axis of the second beam 503 such that they are non-parallel to each other. In particular, in some non-limiting embodiments of the present technology, the printing system controller 316 can be configured to cause the beam modulation component 506 to arrange the first optical axis at an overlap angle 507 relative to the second optical axis corresponding to an overlap between the first focal region of the first beam 501 and the second focal region of the second beam 503.

In specific non-limiting embodiments of the present technology, the components of the printing system 300, such the first laser 502 and the second laser 504, can be arranged such that the overlap angle 507 is an acute angle. It is also contemplated that the lasers 502, 504 could be arranged at non-parallel angles to each other, such that the optical axes respectively associated with the beams 501, 503 arrive at the beam modulation component 506 at a non-parallel angle to each other.

Thus, in some non-limiting embodiments of the present technology, the printing system controller 316 can be configured to cause the beam modulation component 506 to adjust at least one of (1) the overlap angle 507 between the first optical axis of the first beam 501 and the second optical axis of the second beam 503; (2) the first focusing distance 509 of the first beam 501; and (3) the second focusing distance 511 of the second beam 503 such that the respective optical axes of the first beam 501 and the second beam 503 both intersect in the overlapping focal region 605 where the combined energy density value is greater than the threshold energy density value associated with the printing laver. By doing so, the printing system controller 316 is configured to cause sufficient energy density value to create the container markings 199 in the markable region 195 of the printing layer.

Additional components of the printing system 300 are envisioned without departing from the scope of the present technology. For example, in some non-limiting embodiments of the present technology, the printing system 300 can include a camera (such as a Charge-Coupled Device (CCD) camera or an array thereof, not depicted) communicatively coupled to the printing system controller 316 for recognizing the container 190 before applying the container markings 199 thereon. For example, using the camera (not depicted) of the printing system 300, the printing system controller 316 can be configured to define a coordinate system (such as a Cartesian coordinate system, as an example) associated with the container 190 and further determine thereon a location of the markable region 195 defined in the printing layer.

Further, the printing system controller 316 can be configured to receive, as part of program instructions thereof, an indication of point coordinates of points, in the coordinate system associated with the container 190, defining the container markings 199. By doing so, the printing system controller 316 can be configured to identify the given location 515 in the markable region 195 for further forming the overlapping focal region 605 thereat.

Further, to apply the container markings 199 within the markable region 195, the overlapping focal region 605 can be caused to displace along the surface thereof or within a depth thereof. To that end, in some non-limiting embodiments of the present technology, at least some components of the printing system 300, such as the first laser 502, the second laser 504, and the beam modulation component 506 arranged as described above, can be caused to move, such as by a robotic arm (not depicted). Broadly speaking, the robotic arm can include a number of segments (or otherwise linking elements) interconnected by joints, each including a respective individual actuator coupled thereto, such as one of an electric, hydraulic, or pneumatic motor. A given joint can thus allow for at least one of a revolving, yawing, and pitching movement of a respective segment attached thereto mimicking functionality of the human arm. The actuators can further be communicatively coupled to the printing system controller 316 of the printing system 300, whereby the printing system controller 316 can be configured to actuate the actuators of the joints of the robotic arm, thereby providing up to six degrees of freedom to a terminal segment thereof, or “an end effector”, to which the at least some components of the printing system 300 configured for steering the first beam 501 and the second beam 503 can be attached.

In other non-limiting embodiments of the present technology, the robotic arm can comprise a Cartesian coordinate robot, where the joints allow translational movements of the segments attached thereto. Embodiments where the container 190 is additionally caused to move relative to the printing system 300, having formed the overlapping focal region 605, for displacements thereof along the surface of the markable region 195 or within the depth thereof are also envisioned without departing from the scope of the present technology.

In yet other non-limiting embodiments of the present technology, the printing system controller 316 can be configured to displace the overlapping focal region 605 along the surface of the markable region 195 or through the depth of the markable region 195 by rearranging, using the beam modulation component 506 as described above, the optical axes of each one of the first beam 501 and the second beam 503 to form the overlapping focal region 605 at respective locations of the markable region 195 corresponding to the point coordinates defining the container markings 199 therein.

Thus, in some non-limiting embodiments of the present technology, after identifying, based on respective point coordinates, the given location 515 within the markable region 195, the printing system controller 316 can be configured to cause the overlapping focal region 605, formed by the first beam 501 and the second beam 503, to displace to the given location 515 for creating the container markings 199.

With reference to FIGS. 6A and 6B, there are schematically depicted cross-sectional and lateral views of the overlapping focal region 605, respectively, formed at the given location 515 of the markable region 195, in accordance with certain non-limiting embodiments of the present technology.

As it can be appreciated, in the embodiments depicted in FIGS. 6A and 6B, the printing layer has been determined as being the outer skin layer 158 of the container 190, a portion of which has further been chosen as the markable region 195. Thus, the printing system controller 316 can be configured, as described above, to (1) cause the first beam 501 emitted by the first laser 502 and the second beam 503 emitted by the second laser 504 to focus in the overlapping focal region 605; and (2) cause the overlapping focal region 605 to displace to the given location 515 of the markable region 195 for creating the container marking 199 therein.

With reference to FIG. 5 and with continued reference to FIGS. 6A and 6B, according to certain non-limiting embodiments of the present technology, each one of the first focusing distance 509 and the second focusing distance 511 can be adjusted, by the beam modulation component 506, such that an overlap focal region depth 601 of the overlapping focal region 605 is no greater than a printing layer depth 603 of the printing layer, that is, in the present example of FIGS. 6A and 6B, the outer skin layer 158. This may allow creating the container markings 199 only within the printing layer, without touching or damaging other layers of the container 190, such as the at least one middle layer 156 or the inner skin layer 154.

Thus, certain non-limiting embodiments of the printing system 300 can allow creating the container markings 199 on the container 190 more accurately, which may further allow for an increased effectiveness of the process 100 as a whole.

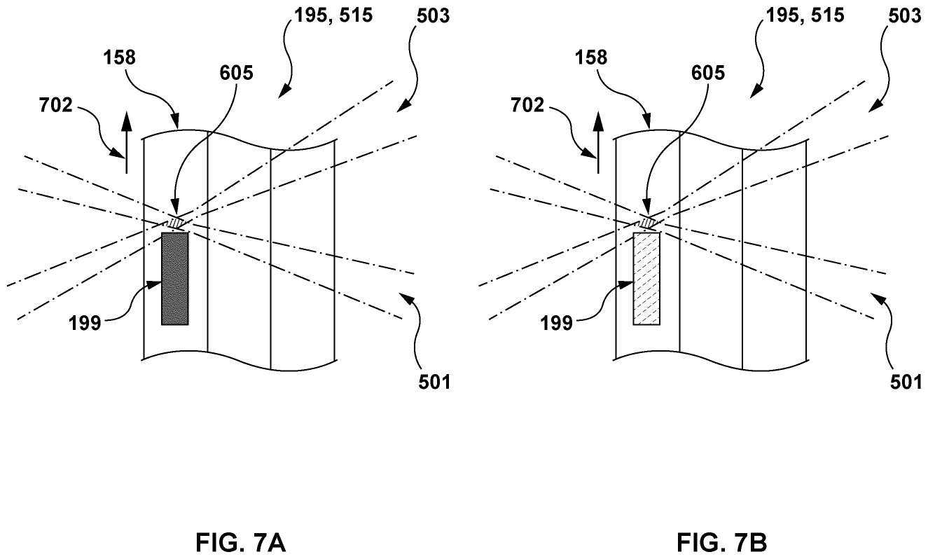

With reference to FIGS. 7A and 7B, there is depicted a schematic diagram of various approaches to creating the container markings 199 in the markable region 195, in accordance with certain non-limiting embodiments of the present technology.

Having identified the given location 515 within the markable region 195, the printing system controller 316 can be configured to cause the overlapping focal region 605 to displace within the markable region 195 in accordance with point coordinates defining the container markings 199—such as along a given direction 702. Further, as mentioned hereinabove, depending on the wavelength of each one of the first beam 501 and the second beam 503, the printing layer can be configured for reacting differently to the combined energy density value produced thereby in the overlapping focal region. More specifically, in those embodiments where each one of the first laser 502 and the second laser 504 are of the first laser type, such as the NIR laser, the container markings 199 formed thereby in the given location 515 can be a carbonization trace inside the markable region 195 of the printing layer, that is, the printing layer depth 603, within appearing to be of dark gray color, as an example.

However, in other embodiments where each one of the first laser 502 and the second laser 504 are of the second laser type, such as the carbon dioxide laser, the container markings 199 formed thereby in the markable region 195 result from foaming the printing layer in the given direction 702. In these embodiments, the container markings 199 can appear to be of light gray or white color, as an example, as depicted in FIG. 7B.

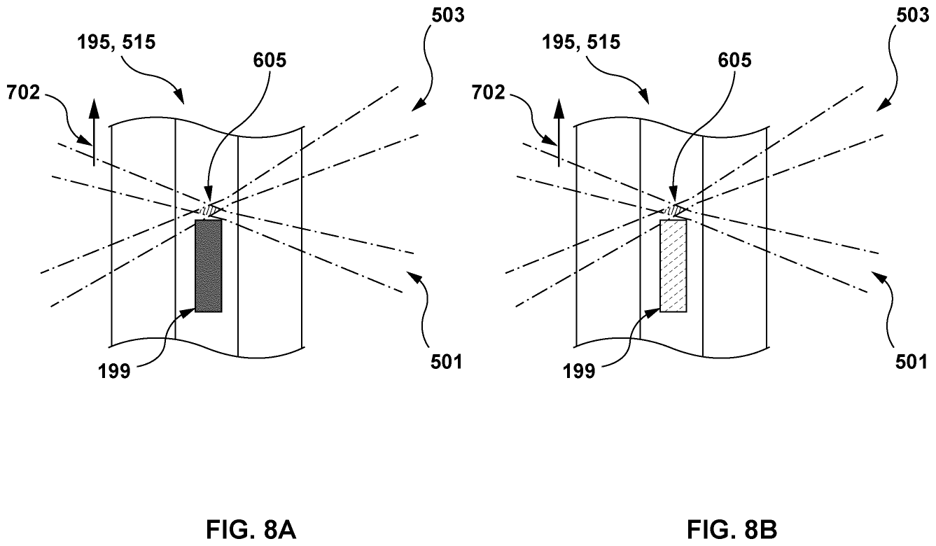

As it can further be appreciated, in other non-limiting embodiments of the present technology, the printing layer can be determined as being, for example, the at least one middle layer 156 of the container 190. Thus, similar to the previous example, the printing system controller 316 can be configured to (1) cause formation of the overlapping focal region 605 in the given location 515 of the markable region 195, defined, in this example, in the at least one middle layer 156; and (2) cause application of the container markings 199 by causing the overlapping focal region 605 to displace within the markable region 195 in the given direction 702, as depicted, in accordance with certain non-limiting embodiments of the present technology, in FIGS. 8A and 8B.

Similarly, in yet other non-limiting embodiments of the present technology, the printing layer can be determined as the inner skin layer 154 for creating the container markings 199 therein as described above.

In yet other non-limiting embodiments of the present technology where the container 190 is a monolayer container, as mentioned above, the printing layer can extend through the entire depth of the wall of the container 190; and the printing system controller 316 can be configured to apply the container marking 199 therewithin in a similar manner as described above.

Further, it should be expressly understood that application of the printing system 300 described above is not limited to containers produced from molded articles, such as the container 190, and may include various other products produced from materials reactive to the laser irradiation having predetermined properties, such as, without limitation, fast-moving consumer goods and packaging material thereof, tyres, water supply pipes, and the like.

Thus, with back reference to FIG. 1, the container printing procedure 14 terminates, and the process 100 advances to the container filling and capping procedure 16.

### Container Filling and Capping Procedure

As mentioned above, the container filling and capping procedure can be executed by the filling and capping system (not depicted) configured to put a cap onto the neck portion 151 of the container 190 and to further enclose a volume defined within the container 190.

As mentioned further above, the container filling and capping procedure 16 can be executed before executing the container printing procedure 14.

The process 100 thus terminates.

Various embodiments having been thus described in detail by way of example, it will be apparent to those skilled in the art that variations and modifications may be made without departing from the invention. The invention includes all such variations and modifications as fall within the scope of the appended claims. As such, the described non-limiting embodiment(s) ought to be considered to be merely illustrative of some of the more prominent features and applications. Other beneficial results can be realized by applying the non-limiting embodiments in a different manner or modifying them in ways known to those familiar with the art. This includes the mixing and matching of features, elements and/or functions between various non-limiting embodiment(s) is expressly contemplated herein so that one of ordinary skill in the art would appreciate from this disclosure that features, elements and/or functions of one embodiment may be incorporated into another embodiment as skill in the art would appreciate from this disclosure that features, elements and/or functions of one embodiment may be incorporated into another embodiment as appropriate, unless described otherwise, above. Although the description is made for particular arrangements and methods, the intent and concept thereof may be suitable and applicable to other arrangements and applications.

1. A system for marking a product, the product including a markable region in which a marking can be created by incident irradiation having an energy above a threshold energy: the system comprising:
a first laser configured to emit a first beam along a first optical axis, the first beam having a first beam energy density when focused which is less than the threshold energy density: and
a second laser configured to emit a second beam along a second optical axis, the second beam having a second beam energy density when focused which is less than the threshold energy density,
wherein the first optical axis and the second optical axis are arranged to intersect in an overlapping focal region:
at least one beam modulator component configured to adjust at least one of:
an angle between the first optical axis of the first beam and the second optical axis of the second beam,
a first focusing distance of the first beam, and
a second focusing distance of the second beam, such that:
the overlapping focal region of the first beam and the second beam is formed at a given location in the markable region of the product, and
the first beam energy density and the second beam energy density combined is greater than the threshold energy density sufficient to create the marking.

2. The system of claim 1, wherein the system is configured to create the markings on a surface of the markable region.

3. The system of claim 1, wherein the system is configured to create the markings within the markable region.

4. The system of claim 1, wherein the first laser and the second laser are configured to cause at least one of a physical change and a chemical reaction at the given location in the markable region of the product.

5. The system of claim 1, wherein each one of the first laser and the second laser are of a first laser type causing carbonization to the given location of the markable region to create the marking therein.

6. The system of claim 1, wherein each one of the first laser and the second laser are of a second laser type causing foaming to the given location of the markable region to create the marking therein.

7. The system of claim 1, wherein:
the first laser and the second laser are chosen from a first laser type and a second laser type: and
the first laser type is configured to emit irradiation of a longer wavelength than that emitted by the second laser type.

8. The system of claim 7, wherein:
the first laser type comprises a carbon dioxide laser; and
the second laser type comprises a Near-Infrared (NIR) laser.

9. The system of claim 1, wherein the system is configured to mark the product having a material which is generally unreactive to irradiation having an energy lower than the threshold energy.

10. The system of claim 9, wherein the system is configured to mark the product having a layered structure including:
an outer skin layer;
at least one middle layer; and
an inner skin layer.

11. The method of claim 10, wherein the layered structure has been produced from at least one thermoplastic material.

12. The method of claim 11, wherein the thermoplastic material is one of polyethylene terephthalate, high-density polyethylene, or polypropylene.

13. The system of claim 10, wherein one of the outer skin layer, the at least one middle layer, and the inner skin layer comprises a printing layer of the product where the marking region is defined for creating the marking therein.

14. The system of claim 13, wherein the at least one beam modulator component is configured to form the overlapping focal region of a smaller depth than that of the printing layer.

15. The system of claim 13, wherein the printing layer includes an additive sensitive to irradiation having the energy above the threshold energy density.

16. The system of claim 10, wherein the product is a container having been produced from a molded article.

17. The system of claim 1, wherein the first optical axis is non-parallel to the second optical axis.

18. The system of claim 17, wherein the first optical axis is arranged at an acute angle to the second optical axis.

19. The system of claim 17, wherein the first optical axis and the second optical axis are arranged at equal angles to a normal of the markable region of the product.
